(19) United States
(12) Patent Application Publication
(10) Pub. No.: US 2024/0056181 A1
(43) Pub. Date: Feb. 15, 2024

(54) FAST MEASUREMTNE APPARATUS FOR OPTICAL LINK DELAY BASED ON OPTICAL MIXING AND DELAY QUANTIZATION

(71) Applicant: Zhejiang University, Hangzhou (CN)

(72) Inventors: Xiaofeng Jin, Hangzhou (CN); Zhiwei Li, Hangzhou (CN); Xiaohuan Sun, Hangzhou (CN); Jie Li, Hangzhou (CN); Xiangdong Jin, Hangzhou (CN); Yinfang Xie, Hangzhou (CN)

(21) Appl. No.: 17/819,627

(22) Filed: Aug. 13, 2022

(51) Int. Cl. H04B 10/077; H04B 17/364

(52) U.S. Cl. CPC H04B 10/0775; H04B 10/0773; H04B 17/364

(57) ABSTRACT

The invention discloses a fast measurement apparatus for optical link delay based on optical mixing and delay quantization. The apparatus uses a high-stability reference source to generate intermediate frequency signal and local oscillator signal, and obtains optical domain radio frequency signals through photon mixing, so as to use for the measurement of optical link delay. After the test signal passes through the link to be tested and the reference link, and then is mixed in the electrical domain, the delay amount information is transmitted to the intermediate frequency, and the influence of port impedance mismatch is eliminated. By rapidly changing the frequency of a series of signals, and quickly detecting the phase and quantifying the delay of the returned intermediate frequency signal, the fast measurement of the optical link delay is realized.

### FIELD OF THE DISCLOSURE

The invention belongs to the technical field of optical measurement, and in particular relates to an fast measurement apparatus for optical link delay based on optical mixing and delay quantification.

### BACKGROUND OF THE DISCLOSURE

Optical fiber communication is widely used in long-distance data exchange due to its large bandwidth, low attenuation, anti-interference, and good confidentiality. Optical fiber networks have been established all over the world, which solves the problem including huge loss, limited available bandwidth source, poor confidentiality in traditional microwave technology.

While optical fiber solves the problem of high-bandwidth communication, it also shines in other areas that are very sensitive to delay.

In the military, the importance of phased array radar in military confrontation is self-evident. It is usually equipped with multiple sets of antennas, and the beam direction of the antenna array is changed by controlling the amplitude and phase of the antenna unit. In order to solve the false delay problem of electrical phase shift, optical fiber is introduced to adjust the true delay of each antenna, so as to accurately locate the target. Phase-shifting technology based on microwave photonic technology brings the characteristics of strong anti-electromagnetic interference, large bandwidth, wide scanning angle, and multi-target tracking to phased array radar. Therefore, it is very important to accurately measure the optical delay in the system. In the fiber optic hydrophone, the sensitivity of the fiber to the environment is used to make it a sensor to perceive the sound of water. The hydrophone generally has a test arm and a reference arm. The difference in the length of the optical fibers of the two arms has a great influence on the performance of the hydrophone. If the hydrophone cannot be kept exactly the same, when the hydroacoustic signal acts on the test arm, the delay of the two arms will be delayed. The inconsistency of the difference causes the phase of the received signal to change, which affects the sensing result. Only by accurately measuring the difference between the two arms can it play the best performance.

With the rapid development of microwave photonics, it also provides a variety of methods for the measurement of fiber delay. OTDR (Optical Time Domain Reflectometry) was first proposed and is still in use today, measuring distances up to tens of kilometers, and has detection functions for breaks and connections in optical fibers. However, this method relies on optical pulses, which are broadened during transmission, and the measured delay is relatively rough, and is limited by the length of the optical pulses, so simultaneous transmission and reception cannot be achieved, and there is a measurement blind spot. Subsequently, OFDR (Optical Frequency Domain Reflectometry) was proposed, which uses the beat frequency results of the emitted light and the returned light to measure the fiber delay, which can achieve very high picosecond-level accuracy, but it has high requirements on the light source. A linear wavelength tunable light source is required, the cost, therefore, will be increased, and the measurement time will be very long, typically on the level of seconds or tens of seconds. Traditional time delay measurement methods include optical coherent domain reflectometry, optical low coherence reflectometry, etc. These measurement methods all have some disadvantages, and cannot achieve both the measurement accuracy and measurement time. Typical measurement times are on the order of seconds.

### SUMMARY OF THE DISCLOSURE

In view of the above, the present invention provides a fast measurement apparatus for optical link delay based on optical mixing and delay quantification, which can quickly measure the relative delay of optical fibers.

A fast measurement apparatus for optical link delay based on optical mixing and delay quantization includes a delay measurement optical circuit, a high-frequency signal generating circuit, a phase comparison circuit, and an MCU control circuit. The high-frequency signal generating circuit is configured to generate high local oscillator signal LO and low intermediate frequency signal IF. The delay measurement optical circuit modulates the local oscillator signal and intermediate frequency signal of the high-frequency signal generation circuit to the optical circuit, and performs optical up-conversion to generate RF signal. After the optical signal passes through the to-be-measured optical fibered or the reference fiber, an electrical signal is generated by the photodetector beat frequency, and at last enters the phase comparison circuit. The local oscillator signal LO and the electrical signal are down-converted to generate IF′. Phase comparison is performed between the IF′ and the IF to obtain a phase change value of the RF signal passing through the link. The MCU control circuit controls the signal generator in the high-frequency signal generating circuit, the first optical switch and the second optical switch in the delay measurement optical circuit, and receives the phase signal from the phase comparison circuit. The MCU obtains multiple sets of phase change values by changing the frequency of the local oscillator signal of the signal generator and switching the optical switches. After a series of calculations, the MCU obtains the optical fiber differential delay.

In some embodiments, the time delay measurement optical path includes a continuous working CW laser, a dual-RF port electro-optic modulator, a to-be-measured optical fiber, a reference fiber, a first optical switch, a second optical switch, and a photodetector. The dual-RF port electro-optic modulation modulates the local oscillator signal LO and the intermediate frequency signal IF from the high-frequency signal generating circuit to the light emitted by the CW laser at the same time for performing optical up-conversion to generate the RF signal. The first and second optical switches control the access of the to-be-measured optical fiber and the reference fiber. After the optical signal passes through the reference fiber, it enters the photodetector and is converted into a radio frequency signal to arrive at the phase comparison circuit.

In some embodiments, the phase comparison circuit includes a mixer and a phase detector. The local oscillator signal LO generated by the signal generator in the high-frequency signal generating circuit and the high-frequency signal RF′ returned by the delay measurement optical path are down-converted to generate IF′. The IF′ and the IF signal of the DDS are phase-detected in the phase detector to obtain the phase change value after the RF signal transmitting through the link.

In some embodiments, the high-frequency signal generating circuit includes: a high-stability reference local oscillator, a signal generator, a DDS (Direct Digital Synthesizer), a first coupler, and a second coupler. The signal generator uses a low phase noise reference signal of the high-stability reference local oscillator to output the output local oscillator signal LO. The low phase noise reference signal and the local oscillator signal LO are sent to the first coupler and DDS, respectively. The first coupler is divided into two channels, which are respectively connected to the electro-optic modulator and the phase comparison circuit. The DDS takes the local oscillator signal as a reference to generate a constant intermediate frequency signal IF, and send the constant intermediate frequency signal IF to the second coupler. The second coupler is separately connected to the electro-optical modulator and the phase comparison circuit, so that the intermediate frequency signal IF participates in optical up-conversion and down-conversion.

The MCU control circuit controls the signal generator in the high-frequency signal generating circuit, the first optical switch and the second optical switch in the delay measurement optical path, and receives the phase signal from the phase comparison circuit. The MCU controls the optical switches to connect to the to-be-measured optical fibered and the reference fiber in turn, quickly switches the frequency of the intermediate frequency signal generated by the signal generator, and obtains multiple sets of phase change values. The MCU quickly calculates the differential delay of the fiber through delay quantification.

In some embodiments, the optical fiber differential delay measurement process is as follows:
(1) MCU controls the first and second optical switches to turn on the to-be-measured optical fiber, the signal generator of the high-frequency signal generating circuit generates the local oscillator signal LO with a frequency f. The DDS generates a stable low IF signal, and the phase comparison circuit obtains the phase change value φₐ of the radio frequency signal.
(2) MCU changes the LO signal generated by the signal generator, and outputs the frequency f₀˜fₙ, respectively; where the difference between f₀˜fₙ and f satisfies a certain multiple relationship k, i.e., (fᵢ−f)/(fᵢ₋₁−f)=k, 1≤i≤n. The phase change values φₐ₀˜φₐₙ are obtained from the phase comparison circuit, respectively.

(3) The MCU controls the first and second light switches to connect the reference fiber, and repeats the above steps to obtain the phase change values φ_{b} and φ_{b0}˜φ_{bn}.
(4) The MCU uses the obtained φₐ, φ_{b}, φₐ₀˜φₐₙ, φ_{b0}˜φ_{bn}, and the used frequency and value k to quickly calculate the delay of the to-be-measure optical fiber relative to the reference fiber.

In some embodiments, the coupler is a 3 dB coupler, the photodetector is a high-frequency broadband photodetector, and the electro-optical modulator is a dual-RF port electro-optical modulator.

In some embodiments, the reference fiber can be regarded as a direct connection between the two optical switches, and the introduction of the reference optical path eliminates the influence of RF impedance matching on the measurement accuracy.

In some embodiments, since the local oscillator signal is a high-frequency signal, the phase-locked loop in the signal generator can be quickly stabilized, so the MCU can quickly change the local oscillator signal generated by the signal generator. Optical switches are electro-optical switches with high-speed switching response. In conclusion, the apparatus can perform fast measurement of optical link delay.

### BRIEF DESCRIPTION OF DRAWINGS

FIG. 1 is a schematic diagram of the apparatus according to the present invention.

### DETAILED DESCRIPTION OF THE DISCLOSURE

In order to describe the present invention more specifically, the technical solutions of the present invention will be described in detail below with reference to the accompanying drawings and specific embodiments.

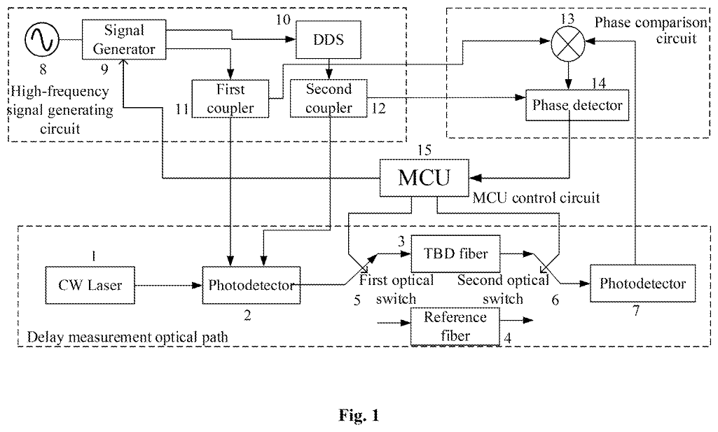

As shown in FIG. 1, the present invention is based on the fast measurement apparatus for optical link delay based on optical mixing and delay quantization. The fast measurement apparatus includes a CW laser 1, an electro-optical modulator 2, a to-be-measured optical fiber 3, a reference optical fiber 4, a first optical switch 5, a second optical switch 6, and a photodetector 7. The dual-RF port electro-optical modulator 2 modulates the local oscillator signal LO and the intermediate frequency signal IF transmitted by the frequency signal generating circuit onto the light emitted by the CW laser 1 to perform optical up-conversion to generate an RF signal. The first optical switch 5 and the second optical switch 6 control the access of the to-be-measured optical fiber and the reference fiber. After the optical signal passes through, it enters the photodetector 7 and is converted into an electrical signal to reach the phase comparison circuit.

The high-frequency signal generating circuit includes a high-stability reference local oscillator 8, a signal generator 9, a DDS (Direct Digital Synthesizer) 10, a first coupler 11, and a second coupler 12. The signal generator 9 uses a low phase noise reference signal of the high-stability reference local oscillator to output the local oscillator signal LO. The low phase noise reference signal and the local oscillator signal LO are sent to the first coupler 11 and the DDS 10, respectively. The first coupler 11 is divided into two channels to connect the electro-optical modulator 2 and the phase comparison circuit, respectively. The DDS uses the local oscillator signal as a reference to generate a constant intermediate frequency signal IF, and sends the constant intermediate frequency signal IF to the second coupler 12. The second coupler 12 is separately connected to the electro-optical modulator 2 and the phase comparison circuit, so that the intermediate frequency signal IF participates in the optical up-conversion and down-conversion.

The phase comparison circuit includes a mixer 13 and a phase detector 14. The local oscillator signal LO generated by the signal generator 9 in the high-frequency signal generating circuit and the high-frequency signal RF′ returned by the delay measurement optical path are performed down conversion in the mixer 13 to generate the IF′. The IF′ and the IF generated by the DDS 10 are performed phase detection in the phase detector 14 to obtain the phase change value after the RF signal is transmitted through the link.

The MCU 15 rapidly changes the frequency of the LO signal of the signal generator 9, and obtains two sets of phase measurement results by changing the positions of the optical switches 5 and 6, and at last calculates the optical fiber differential delay.

In this embodiment, after the measurement is started, the MCU 15 controls the optical switches 5 and 6 to connect the to-be-measured optical fiber 3, and the signal generator 9 generates a local oscillator signal with a frequency f. Then the MCU 15 records the phase change value obtained by the phase detector 14, marked as φₐ. Then the MCU 15 controls the signal generator 9 to change the frequency, and sequentially outputs a group of frequencies f₀˜fₙ whose difference is a proportional sequence to f, where the difference between f₀˜fₙ and f satisfies a certain multiple relationship k, i.e., (fᵢ−f)/(fᵢ₋₁−f)=k. The MCI) obtains a set of phases φₐ₀˜φₘ from the phase comparison circuit.

After that, the MCU controls the first and second optical switches 5 and 6 to connect the reference fiber 4, so that the signal generator 9 generates the same frequency f, f₀˜fₙ, and obtains another phase change value φ_{b} and another set of phases φ_{b0}˜φ_{bn}.

Then the delay of the to-be-measured optical fibered relative to the reference fiber can be calculated by the following formula:

$$t = {\sum }_{i = 0}^{n - 1} ⌊ \frac{{φ}_{Di}}{{φ}_{Q}} ⌋ \cdot \frac{1}{k \cdot ( {f}_{i} - f )} + \frac{1}{{f}_{n} - f} \cdot \frac{{φ}_{Dn}}{360} \qquad ( 1 )$$

$$where ,$$

$${φ}_{ai} - {φ}_{u} = {φ}_{ai}^{′} , {φ}_{bi} - {φ}_{b} = {φ}_{bi}^{′} , {φ}_{Di} = {φ}_{bi}^{′} - {φ}_{ai}^{′} , {φ}_{Q} = \frac{360}{k} , 0 \leq i \leq n .$$

In this embodiment, the reference fiber can be regarded as a direct connection between the two optical switches, and the introduction of the reference optical path eliminates the influence of RF impedance matching on the measurement accuracy.

In this embodiment, the IF and LO output by the high-frequency signal generating circuit are modulated onto the light through a dual-RF port electro-optical modulator, and the light is up-converted to generate an RF signal. After the RF signal is transmitted through the link, the phase changes to become RF′, and after the frequency beat at the photodetector, it becomes an electrical signal. The electrical signal arrives at the phase comparison circuit and is down-converted with the LO signal of the high-frequency signal generating circuit to obtain IF′. The IF′ and the IF of the high-frequency signal generating circuit are phase detected, that is, the phase change of the radio frequency signal is transferred to the intermediate frequency for detection by using up-conversion and down-conversion. The local oscillator signal is a high-frequency signal, and the phase-locked loop in the signal generator can be stabilized in a very short time, so the MCU can quickly change the LO signal generated by the signal generator. The optical switch is an electro-optical switch, which can be switched in a short time. The measurement method utilizes the feature that there is no phase ambiguity when the delay value is measured by the phase in one cycle, removes the influence of the phase ambiguity on the measurement, and quantifies the measurement results through the phase relationship between the frequency multiplications, so that it is more precise. In conclusion, the apparatus can quickly measure the optical link delay and obtain accurate results.

The above description of the embodiments is for the convenience of those of ordinary skill in the art to understand and apply the present invention. It will be apparent to those skilled in the art that various modifications to the above-described embodiments can be readily made, and the general principles described herein can be applied to other embodiments without inventive effort. Therefore, the present invention is not limited to the above-mentioned embodiments, and improvements and modifications made to the present invention by those skilled in the art according to the disclosure of the present invention should all fall within the protection scope of the present invention.

What is claimed is:

1. A fast measurement apparatus for optical link delay based on optical mixing and delay quantification, comprising a delay measurement optical path, a high-frequency signal generating circuit, a phase comparison circuit, and a MCU control circuit;
the high-frequency signal generating circuit is configured to generate a local oscillator signal LO and an intermediate frequency signal IF;
the delay measurement optical path is configured to modulate the local oscillator signal and the intermediate frequency signal to an optical path, and perform optical up-conversion to generate a radio frequency signal RF; after the optical signal passes through a to-be-measured fiber or a reference fiber, an electrical signal is formed by beat at a photodetector, and at last the electrical signal reaches the phase comparison circuit;
the phase comparison circuit is configured to utilize the local oscillator signal LO and a radio frequency signal RF′ returned by the delay measurement optical path to perform down-conversion, and an intermediate frequency signal IF′ obtained by the down-conversion and the original intermediate frequency signal IF are phase-detected to obtain a phase change value of a radio frequency signal RF transmitting through the link;
the MCU control circuit is configured to control a signal generator in the high-frequency signal generating circuit, a first optical switch and a second optical switch in the delay measurement optical circuit, and receive a phase signal of the phase comparison circuit; the MCU is configured to control the first optical switch and the second switch to connect the optical path to the to-be-measured optical fiber and the reference fiber in turn, and quickly switches a local oscillator signal frequency generated by the signal generator to obtain multiple sets of phase change values; the MCU is configured to quickly obtains a differential delay of the to-be-measured optical fiber through a delay quantization calculation.

2. The measurement apparatus according to claim 1, wherein the delay measurement optical path comprises a continuous working CW laser, a dual radio frequency port electro-optical modulator, the to-be-measured optical fiber, the reference optical fiber, the first optical switch, the second optical fiber, a photodetector; wherein the dual-RF port electro-optic modulator is configured to modulate the local oscillator signal LO and intermediate frequency signal IF to a light emitted by the CW laser at the same time, and perform optical up-conversion to generate the radio frequency signal RF; the first and second optical switches are configured to control accesses of the to-be-measured optical fibered and the reference fiber; after passes through the to-be-measured optical fiber the reference fiber, the optical signal enters the photodetector and is converted into an electrical signal to reach the phase comparison circuit.

3. The measurement apparatus according to claim 1, wherein the phase comparison circuit comprises a frequency mixer and a phase detector; the local oscillator signal LO and a high-frequency signal RF′ returned by the delay measurement optical path are down-converted at the frequency mixer to generate the intermediate frequency signal IF′; the intermediate frequency signal IF′ and the intermediate signal IF are phase-detected in the phase detector to obtain a phase change value of the radio frequency signal RF transmitting through the link.

4. The measurement apparatus according to claim 2, wherein the high-frequency signal generating circuit comprises a high-stable reference local oscillator, a signal generator, a DDS (Direct Digital Synthesizer), a first coupler, a second coupler; the signal generator is configured to output the local oscillator signal LO by using the low phase noise reference signal of the high-stable reference local oscillator; the local oscillator signal LO and the low phase noise reference signal are transmitted to the first coupler and the DDS, respectively; the first coupler is divided into two channels, which are respectively connected to the electro-optic modulator and the phase comparison circuit; the DDS takes the local oscillator signal LO as a reference to generate a constant intermediate frequency signal IF; the constant intermediate frequency signal IF is transmitted to the second coupler; the second coupler is separately connected to the electro-optical modulator and the phase comparison circuit, so that the intermediate frequency signal IF participates in optical up-conversion and down-conversion.

5. The measurement apparatus according to claim 4, wherein the optical fiber differential delay measurement process is as follows:
(1) controlling, by the MCU control circuit, the first optical switch and the second optical switch to turn on the to-be-measured optical fiber; wherein the signal generator of the high-frequency signal generating circuit generates the local oscillator signal LO with a frequency f; the DDS outputs a stable intermediate frequency signal IF, and the phase detector of the phase comparison circuit detects obtains the phase change value φₐ of the radio frequency signal RF;
(2) changing, by the MCU control circuit, the local oscillator signal LO generated by the signal generator, and outputs the frequency f₀˜fₙ, respectively; where the difference between f₀˜fₙ and f satisfies a certain multiple relationship k, i.e., (fᵢ−f)/(fᵢ₋₁−f)=k, 1≤i≤n; the phase change values φₐ₀˜φₐₙ are obtained from the phase comparison circuit, respectively;
(3) controlling, by the MCU control circuit, the first and second optical switches to connect the reference fiber, and repeating the above steps to obtain the phase change value φ_{b} and φ_{b0}˜φ_{bn};
(4) obtaining, by the MCU control circuit, φₐ, φ_{b}, φₐ₀˜φₐₙ, φ_{b0}˜φ_{bn}, the frequency and the value k to quickly calculate the delay of the to-be-measured optical fiber relative to the reference fiber.
